(19) United States
(12) Patent Application Publication
(10) Pub. No.: US 2026/0252276 A1
(43) Pub. Date: Aug. 27, 2026

(54) FLASH STORAGE CONFIRMED DETECTION RESPONSE

(71) Applicant: Micron Technology, Inc., Boise, ID (US)

(72) Inventors: Melissa I. Uribe, EI Dorado Hills, CA (US); Marco Montagnana, Cormano (IT); Antonino Pollio, Vico Equense (IT); Tal Sharifie, Lehavim (IL); Alessandro Novati, Verano Brianza (IT); Giuseppe Ferrari, Napoli (IT); Paolo Papa, Grumo Nevano (IT)

(21) Appl. No.: 19/548,449

(22) Filed: Feb. 24, 2026

Related U.S. Application Data
(60) Provisional application No. 63/762,939, filed on Feb. 25, 2025.

(51) Int. Cl. G06F 3/06

(52) U.S. Cl. CPC G06F 3/0659; G06F 3/0604; G06F 3/0673

(57) ABSTRACT

Systems and methods are disclosed, including receiving, by a memory system, a memory command from a host system; performing, by the memory system, data error detection for memory data associated with the memory command; monitoring for memory system faults when performing the memory command; returning a response message to the host system for the memory command regarding the data error detection when the monitoring for memory system faults is completed and a memory system fault is not detected; and returning no response message to the host system when the memory system fault is detected.

### PRIORITY APPLICATION

This application claims the benefit of priority to U.S. Provisional Application Ser. No. 63/762,939, filed Feb. 25, 2025, which is incorporated herein by reference in its entirety.

### BACKGROUND

Memory devices are semiconductor circuits that provide electronic storage of data for a host system (e.g., a computer or other electronic device). Memory devices may be volatile or non-volatile. Volatile memory requires power to maintain data and includes devices such as random-access memory (RAM), static random-access memory (SRAM), dynamic random-access memory (DRAM), or synchronous dynamic random-access memory (SDRAM), among others.

Host systems (or hosts) typically include a host processor, a first amount of main memory (e.g., often volatile memory, such as DRAM) to support the host processor, and one or more memory systems (e.g., often non-volatile memory, such as flash memory, and may include volatile memory) that provide additional storage to retain data in addition to or separate from the main memory.

A memory system can include a memory control unit and one or more memory devices, including a number of dies or logical units (LUNs). In certain examples, each die can include a number of memory arrays and peripheral circuitry thereon, such as die logic or a die processor. The memory control unit can include interface circuitry configured to communicate with a host (e.g., the host processor or interface circuitry) through a communication link (e.g., a bidirectional parallel or serial communication interface). The memory control unit can receive commands or operations from the host system in association with memory operations or instructions, such as read or write operations to transfer data (e.g., user data and associated integrity data, such as error data or address data, etc.) between the memory devices and the host device, erase operations to erase data from the memory devices, perform drive management operations (e.g., data migration, garbage collection, block retirement), etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example computing system including a host system and a memory system.

FIG. 2 is a block diagram of portions of an example of a memory system.

FIG. 3 is a block diagram showing an example of memory data error detection and memory system fault detection in a memory system.

FIG. 4 is a block diagram showing another example of memory data error detection and memory system fault detection in a memory system.

FIG. 5 is a flow diagram of an example of a method of operating a computing system.

FIG. 6 illustrates an example block diagram of a computing system.

### DETAILED DESCRIPTION

Software (e.g., programs), instructions, operating systems (OS), and other data are typically stored on storage systems and accessed for use by a host processor. Main memory (e.g., RAM) is typically faster, more expensive, and a different type of memory device (e.g., volatile) than a majority of the memory devices of the memory system (e.g., non-volatile, such as an SSD, etc.). In addition to the main memory, host devices can include different levels of volatile memory, such as a group of static memory (e.g., a cache, often SRAM), often faster than the main memory, in certain examples, configured to operate at speeds close to or exceeding the speed of the host processor, but with lower density and higher cost. Memory systems are sometimes used for critical applications, such as automotive, industrial, aerospace, defense, railway, and medical systems. Memory systems for critical applications can include safety mechanisms to detect and correct failures. These safety mechanisms should be reliable to detect and correct application system failures.

Memory devices include individual memory die, which may, for example, include a storage region comprising one or more arrays of memory cells, implementing one (or more) selected storage technologies. Such memory die will often include support circuitry for operating the memory array(s). Other examples, sometimes known generally as “managed memory devices,” include assemblies of one or more memory die associated with controller functionality configured to control operation of the one or more memory dies. Such controller functionality can simplify interoperability with an external host device. In such managed memory devices, the controller functionality may be implemented on one or more dies also incorporating a memory array, or on a separate die. In other examples, one or more memory devices may be combined with controller functionality to form a solid-state drive (SSD) storage volume.

Embodiments of the present disclosure are described in the example of managed memory devices implementing NAND flash memory cells. These examples can be referred to as managed NAND or mNAND devices. These examples, however, are not limiting on the scope of the disclosure, which may be implemented in other forms of memory devices and/or with other forms of storage technology.

Both NOR and NAND flash architecture semiconductor memory arrays are accessed through decoders that activate specific memory cells by selecting the word line coupled to their gates. In a NOR architecture semiconductor memory array, once activated, the selected memory cells place their data values on bit lines, causing different currents to flow depending on the state at which a particular cell is programmed. In a NAND architecture semiconductor memory array, a high bias voltage is applied to a drain-side select gate (SGD) line. Word lines coupled to the gates of the unselected memory cells of each group are driven at a specified pass voltage (e.g., Vpass) to operate the unselected memory cells of each group as pass transistors (e.g., to pass current in a manner unrestricted by their stored data values). Current then flows from the source line to the bit line through each series coupled group, restricted only by the selected memory cells of each group, placing current encoded data values of selected memory cells on the bit lines.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can also represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices may be configured and operated in accordance with recognized industry standards. For example, managed NAND devices may be (as non-limiting examples), a Universal Flash Storage (UFS™) device, or an embedded MMC device (eMMC™), etc. For example, in the case of the above examples, UFS devices may be configured in accordance with Joint Electron Device Engineering Council (JEDEC) standards (e.g., JEDEC standard JESD223D, entitled JEDEC UFS Flash Storage 3.0, etc., and/or updates or subsequent versions to such standard). Similarly, identified eMMC devices may be configured in accordance with JEDEC standard JESD84-A51, entitled “JEDEC eMMC standard 5.1”, again, and/or updates or subsequent versions to such standard.

An SSD can be used as, among other things, the main storage device of a computer, having advantages over traditional hard drives with moving parts with respect to, for example, performance, size, weight, ruggedness, operating temperature range, and power consumption. For example, SSDs can have reduced seek time, latency, or other delay associated with magnetic disk drives (e.g., electromechanical, etc.). SSDs use non-volatile memory cells, such as flash memory cells to obviate internal battery supply requirements, thus allowing the drive to be more versatile and compact. Managed memory devices, for example managed NAND devices, can be used as primary or ancillary memory in various forms of electronic devices, and are commonly used in mobile devices.

Managed memory devices can include a number of memory devices, including a number of dies or logical units (e.g., logical unit numbers or LUNs), and can include one or more processors or other controllers performing logic functions required to operate the memory devices or interface with external systems. Such managed memory devices can include one or more flash memory dies, including a number of memory arrays and peripheral circuitry thereon. The flash memory arrays can include a number of blocks of memory cells organized into a number of physical pages. Managed NAND devices can include one or more arrays of volatile and/or nonvolatile memory separate from the NAND storage array, and either within or separate from a controller. Both SSDs and managed NAND devices can receive commands from a host or a host in association with memory operations, such as read or write operations to transfer data (e.g., user data and associated integrity data, such as error data and address data, etc.) between the memory devices and the host, or erase operations to erase data from the memory devices.

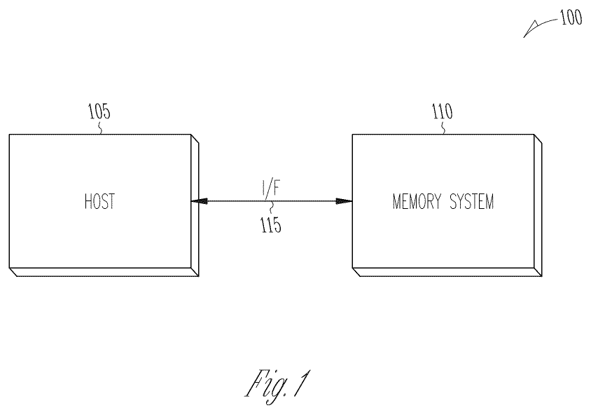

FIG. 1 illustrates an example computing system 100 including a host 105 and a memory system 110. The host 105 can include a host processor, a central processing unit, or one or more other device, processor, or controller. The memory system 110 can include one or more other memory devices, and the communication interface 115 (I/F) can include one or more other interfaces, depending on the host 105 and the memory system 110. Each of the host 105 and the memory system 110 can include a number of receiver or driver circuits configured to send or receive signals over the communication interface 115, or interface circuits, such as data control units, sampling circuits, or other intermedia circuits configured to process data to be communicated over, or otherwise process data received from the communication interface 115 for use by the host 105, the memory system 110, or one or more other circuits or devices.

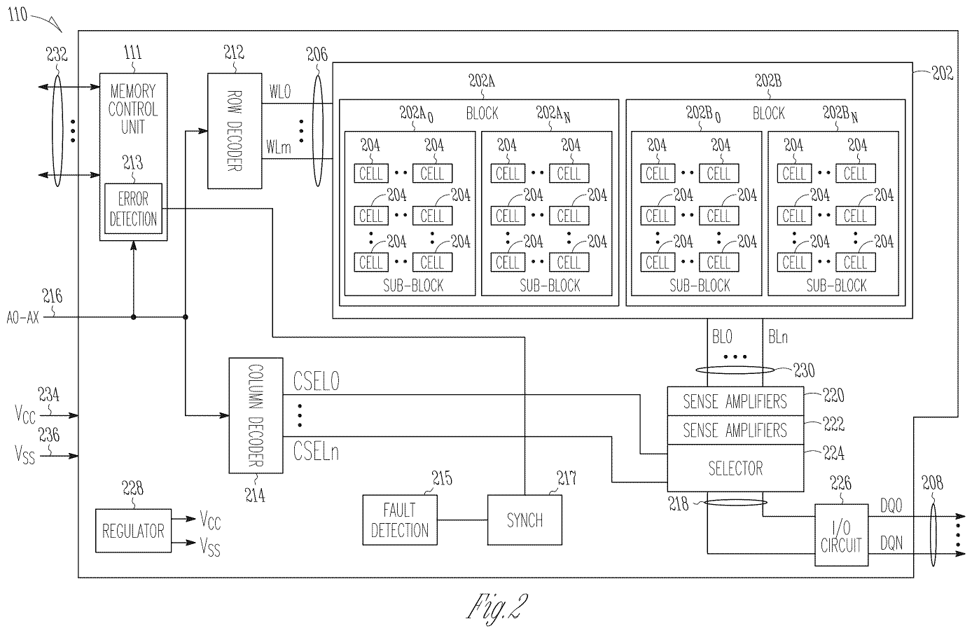

FIG. 2 illustrates an example block diagram of portions of a memory system 110 including a memory array 202 having a plurality of memory cells 204, and one or more circuits or components to provide communication with, or perform one or more memory operations on, the memory array 202. Although shown with a single memory array 202, in other examples, one or more additional memory arrays, dies, or LUNs can be included herein. The memory system 110 can include a row decoder 212, a column decoder 214, sense amplifiers 220, a page buffer 222, a selector 224, an input/output (I/O) circuit 226, and a memory control unit 111.

The memory cells 204 of the memory array 202 can be arranged in blocks, such as first and second blocks 202A, 202B. Each block can include sub-blocks. For example, the first block 202A can include first and second sub-blocks 202A₀, 202Aₙ, and the second block 202B can include first and second sub-blocks 202B₀, 202Bₙ. Each sub-block can include a number of physical pages, each page including a number of memory cells 204. Although illustrated herein as having two blocks, each block having two sub-blocks, and each sub-block having a number of memory cells 204, in other examples, the memory array 202 can include more or fewer blocks, sub-blocks, memory cells, etc. In other examples, the memory cells 204 can be arranged in a number of rows, columns, pages, sub-blocks, blocks, etc., and accessed using, for example, access lines 206, first data lines 230, or one or more select gates, source lines, etc.

The memory control unit 111 can control memory operations of the memory system 110 according to one or more signals or instructions received on control lines 232, including, for example, one or more clock signals or control signals that indicate a desired operation (e.g., write, read, erase, etc.), or address signals (A0-AX) received on one or more address lines 216. One or more devices external to the memory system 110 can control the values of the control signals on the control lines 232, or the address signals on the address line 216. Examples of devices external to the memory system 110 can include, but are not limited to, a host, a memory control unit, a processor, or one or more circuits or components not illustrated in FIG. 2.

The memory system 110 can use access lines 206 and first data lines 230 to transfer data to (e.g., a write or erase operation) or from (e.g., a read operation) one or more of the memory cells 204. The row decoder 212 and the column decoder 214 can receive and decode the address signals (A0-AX) from the address line 216, can determine which of the memory cells 204 are to be accessed, and can provide signals to one or more of the access lines 206 (e.g., one or more of a plurality of word lines (WL0-WLm)) or the first data lines 230 (e.g., one or more of a plurality of bit lines (BL0-BLn)), such as described above.

The memory system 110 can include sense circuitry, such as the sense amplifiers 220, configured to determine the values of data on (e.g., read), or to determine the values of data to be written to, the memory cells 204 using the first data lines 230. For example, in a selected string of memory cells 204, one or more of the sense amplifiers 220 can read a logic level in the selected memory cell 204 in response to a read current flowing in the memory array 202 through the selected string to the data lines 230.

One or more devices external to the memory system 110 can communicate with the memory system 110 using the I/O lines (DQ0-DQN) 208, address lines 216 (A0-AX), or control lines 232. The input/output (I/O) circuit 226 can transfer values of data in or out of the memory system 110, such as in or out of the page buffer 222 or the memory array 202, using the I/O lines 208, according to, for example, the control lines 232 and address lines 216. The page buffer 222 can store data received from the one or more devices external to the memory system 110 before the data is programmed into relevant portions of the memory array 202 or can store data read from the memory array 202 before the data is transmitted to the one or more devices external to the memory system 110.

The column decoder 214 can receive and decode address signals (A0-AX) into one or more column select signals (CSEL0-CSELn). The selector 224 (e.g., a select circuit) can receive the column select signals (CSEL0-CSELn) and select data in the page buffer 222 representing values of data to be read from or to be programmed into memory cells 204. Selected data can be transferred between the page buffer 222 and the I/O circuit 226 using second data lines 218.

The memory control unit 111 can receive positive and negative supply signals, such as a supply voltage (Vcc) 234 and a negative supply (Vss) 236 (e.g., a ground potential), from an external source or supply (e.g., an internal or external battery, an AC-to-DC converter, etc.). In certain examples, the memory control unit 111 can include a regulator 228 to internally provide positive or negative supply signals.

The memory control unit 111 includes error detection circuitry 213 to detect errors in memory data. In certain examples, the error detection circuitry 213 may detect errors using, among other things, cyclic redundancy check (CRC) and may detect and correct errors using Error Correcting Code (ECC). The error detection circuitry 213 may detect errors in memory read data and in memory write data. The memory control unit 111 may also include circuitry to detect address faults, firmware loading faults, and configuration fuse faults.

The computing system 100 of FIG. 1 may have a safety-critical application such as autonomous operation or partially autonomous operation of a vehicle or industrial machine. A memory system fault can cause errors in data and can also impact the ability of the error detection circuitry 213 to detect memory data errors. This can result in one or more of corrupt data being returned to the host 105, data read from the wrong address being returned to the host 105, loss of data from the host 105, data from the host being written to the wrong address, or failure of the memory system 110 to respond to a command from the host 105. The computing system 100 for a safety-critical application may incorporate safety mechanisms to avoid or resolve system failures.

The memory system 110 in FIG. 2 includes fault detection circuitry 215 to detect faults in the memory system 110. The fault detection circuitry 215 can include logic circuitry and sensing circuitry to detect system faults in the memory system 110, such as clock faults, voltage faults, and other faults that affect overall function of the memory system. For example, the fault detection circuitry 215 can include one or more voltage or current sensing circuits to detect a fault in the circuit supply of the memory system 110. The fault detection circuitry 215 can include a clock monitor circuit to detect a clock fault in the memory system 110. The fault detection circuitry 215 can include logic circuitry to detect a firmware fault in the memory system 110. The fault detection circuitry 215 can include other circuitry to detect further examples of memory system faults. The memory system can include synchronization circuitry 217 to synchronize the detection of memory system faults with detection of memory errors.

When completing a memory command from the host, the memory control unit 111 may return a response message to the host 105. For example, for a memory write command, the memory control unit 111 may return a response message to the host 105 that the memory write command is completed and a status that no error was detected. For a memory read command, the memory control unit 111 may return the read data and a response message to the host 105 that the memory read command completed and a status that no error was detected.

When the memory control unit 111 detects a data fault or some types of memory system faults, the memory control unit 111 may return a response message to the host 105 indicating an error occurred for the memory operation requested by the host 105. For a UFS device, the response message may be a response UFS Protocol Information Unit (UPIU). For an eMMC device, the response message may update a status register. For an SSD, the response message may update a completion queue. For some types of memory system faults (e.g., a circuit supply fault), it may be desired for the memory system 110 to drop the communication link with the host 105 to prevent corrupt or wrong data being received and used by the host 105. A complication can arise if the memory system fault is slow to be detected or reported. If the memory system fault affects the ability of the memory system 110 to detect errors, a situation may occur in which a response is returned by the memory control unit before the memory system fault is detected or reported. The response message may indicate a successful memory command even though the write data or the read data has errors.

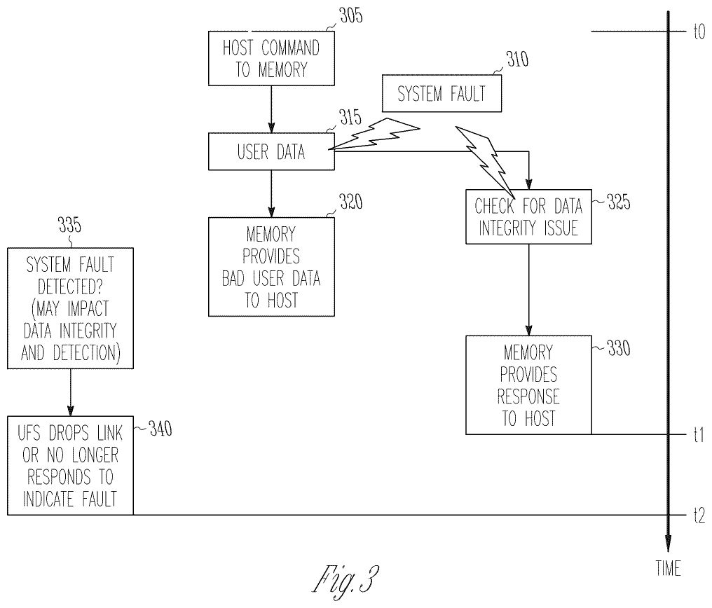

FIG. 3 is a block diagram that illustrates this race condition between memory data error detection and memory system fault detection. The time axis on the right of the diagram shows the time sequence of events. At block 305, the host 105 sends a command to the memory system 110 at time t0. At block 310, a memory system fault occurs. The memory system fault is not necessarily directly related to a fault in reading or writing memory but may be a fault that impacts data and the ability of the memory system 110 to detect data errors. For instance, a circuit supply fault, a memory system clock fault, or a memory system firmware fault may impact data and the functioning of error detection circuitry to detect data errors.

At block 315, the memory system fault corrupts user data (e.g., memory read data or memory write data) and bad user data may be provided to the host 105 at block 320. At block 325, the error detection circuitry 213 of the memory control unit 111 checks for any data integrity issues. The diagram shows that the memory system fault at block 310 may affect the check for data integrity. At block 330, the memory control unit 111 returns a response message to the host at time t1 with status of the results of the memory command. The response message may include the bad user data and the results of the check for data errors.

While the memory command is being performed, the memory system 110 monitors for memory system faults at block 335. At block 340, a memory system fault is detected and the memory system 110 drops the communication link to the host 105 at time t2 or sends no response message to the host 105. It can be seen in the diagram that the response message can be sent before the check for memory system faults is completed. If the system fault impacts the ability of the memory control unit 111 to check integrity of the data, errors in the data may not be reported and the host 105 can receive bad data.

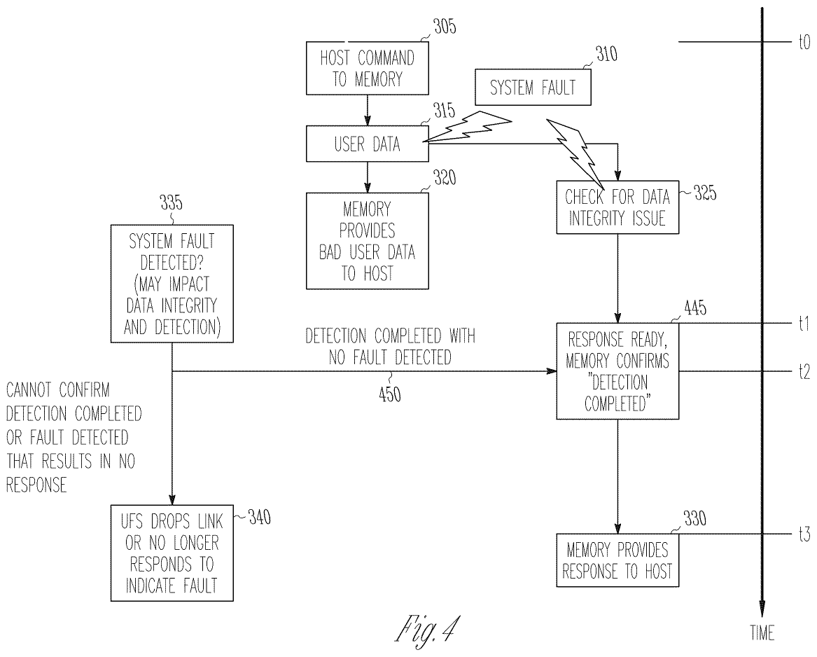

FIG. 4 is a block diagram showing another example of memory data error detection and memory system fault detection in a memory system 110. The events are the same as in the example of FIG. 3 except that after the check for data integrity issues at block 325, the returning of response message is held up or delayed at time t1. At block 445, the response message is held until the check for memory system faults at block 335 completes at time t2. When the indication 450 is produced that the memory system fault detection is completed and no memory system fault was detected, the memory control unit 111 sends the response message to the host 105 at time t3. This prevents the race condition in the example of FIG. 3. At block 340 in FIG. 4, the memory system 110 drops the communication link to the host 105 or sends no response message to the host 105 when a memory system fault is detected or the memory control unit 111 cannot confirm that the system fault detection was completed. The memory control unit 111 may receive an indication (e.g., a signal) from the fault detection circuitry 215 when a check for memory system faults is completed. If the memory control unit 111 does not receive the indication within a specified time, the memory control unit 111 sends no response message to the host 105.

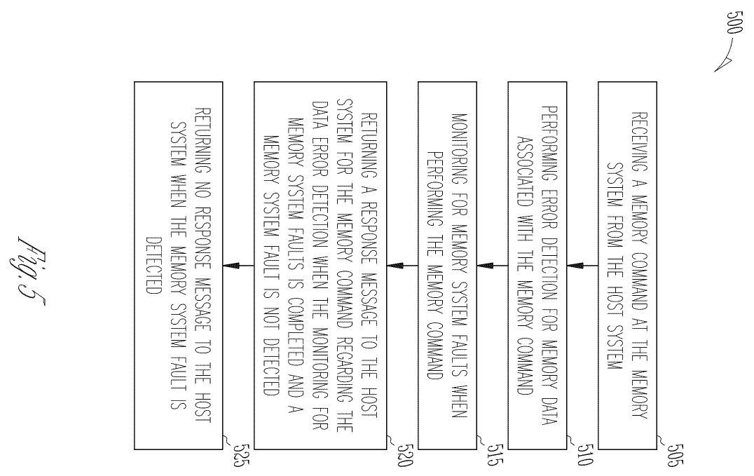

FIG. 5 is a flow diagram of an example of a method 500 of operating a computing system (e.g., the computing system 100 of FIG. 1). The method 500 coordinates the timing of the response message and the memory system fault detection (as in FIG. 4) to make the safety mechanisms of the computing system 100 more reliable.

At block 505, a memory command from the host 105 is received by the memory system 110. The memory command may be a memory read command, memory write command, or other memory command that accesses the memory array 202 of the memory system 110. At block 510, the memory system 110 performs data error detection for memory data associated with the memory command. For instance, the error detection circuitry 213 of the memory control unit 111 may check read data for errors as part of a memory read command or check data written to memory for errors as part of a memory write command. At block 515, the memory system 110 also monitors for memory system faults when performing the memory command.

At block 520, the memory control unit 111 returns a response message to the host 105 to indicate status of the memory command. The memory control unit 111 returns the response message when the monitoring for memory system faults is completed and a memory system fault is not detected. The response message is returned when the monitoring for memory system faults is completed regardless of whether or not a data error occurred for the memory command. For instance, if the memory command is a memory read command for which no data errors are detected, the response message may include one or more data frames that include the read data and a response frame indicating no data errors. If a data error is detected, the response message may include a response frame indicating that a data error occurred.

At block 525, the memory control unit 111 returns no response message to the host 105 when a memory system fault is detected. In some examples, the host 105 establishes a communication link with the memory system 110 and the memory system 110 receives the memory commands and returns response messages to the host 105 via the communication link. The memory system 110 drops or terminates the communication link without sending a response message when a memory system fault is detected. In some examples, the memory system 110 merely stops responding to the host system when a memory system fault is detected, and the communication between the host 105 and the memory system 110 eventually times out. The memory control unit 111 may also send no response to the host 105 when the memory control unit 111 cannot determine that the memory system fault monitoring was completed. For instance, the memory control unit 111 may not respond to the host 105 when the memory system fault prevents a confirmation of memory system check completion from being produced and received by the memory control unit 111. The systems and methods described herein improve the safety mechanisms for memory operations in safety critical applications.

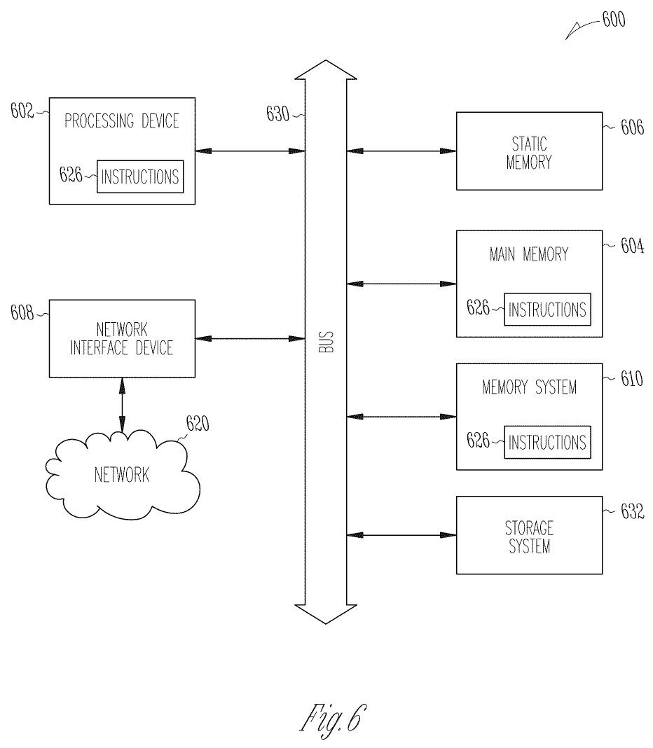

FIG. 6 illustrates a block diagram of an example machine 600 (e.g., a computing system) upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a network node. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, an IoT device, an automotive computing system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 600 (e.g., computing system) may include a processing device 602 (e.g., a hardware processor, a central processing unit (CPU), a graphics processing unit (GPU), a hardware processor core, or any combination thereof, etc.), a main memory 604 (e.g., read-only memory (ROM), dynamic random-access memory (DRAM) such as synchronous DRAM (SDRAM) or Rambus DRAM (RDRAM), etc.), a static memory 606 (e.g., static random-access memory (SRAM), etc.), a memory system 610, and a storage system 632, some or all of which may communicate with each other via a communication interface (e.g., a bus) 630.

The processing device 602 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 can be configured to execute instructions 626 for performing the operations and steps discussed herein. The computer system can further include a network interface device 608 to communicate over a network 620.

The memory system 610 can include a machine-readable storage medium (also known as a computer-readable medium) on which is stored one or more sets of instructions 626 or software embodying any one or more of the methodologies or functions described herein. The instructions 626 can also reside, completely or at least partially, within the main memory 604 or within the processing device 602 during execution thereof by the computer system, the main memory 604 and the processing device 602 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 600 may further include a display unit, an alphanumeric input device (e.g., a keyboard), and a user interface (UI) navigation device (e.g., a mouse). In an example, one or more of the display units, the input device, or the UI navigation device may be a touch screen display. The machine a signal generation device (e.g., a speaker), or one or more sensors, such as a global positioning system (GPS) sensor, compass, accelerometer, or one or more other sensors. The machine 600 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 626 (e.g., software, programs, an operating system (OS), etc.) or other data is stored on the storage system 632 can be accessed by the main memory 604 for use by the processing device 602. The main memory 604 (e.g., DRAM) is typically fast, but volatile, and thus a different type of storage than the storage system 632 (e.g., an SSD), which is suitable for long-term storage, including while in an “off” condition. The instructions 626 or data in use by a user or the machine 600 are typically loaded in the main memory 604 for use by the processing device 602. When the main memory 604 is full, virtual space from the memory system 610 can be allocated to supplement the main memory 604; however, because the memory system 610 device is typically slower than the main memory 604, and write speeds are typically at least twice as slow as read speeds, use of virtual memory can greatly reduce user experience due to storage system latency (in contrast to the main memory 604, e.g., DRAM). Further, use of the storage system 632 for virtual memory can greatly reduce the usable lifespan of the storage system 632.

The instructions 626 may further be transmitted or received over a network 620 using a transmission medium via the network interface device 608 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 608 may include one or more physical jacks (e.g., Ethernet, coaxial, or phone jacks) or one or more antennas to connect to the network 620. In an example, the network interface device 608 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

In some embodiments described herein, different doping configurations may be applied to a select gate source (SGS), a control gate (CG), and a select gate drain (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (i.e., the memory cell may be programmed to an erased state).

According to one or more embodiments of the present disclosure, a memory control unit (e.g., a processor, controller, firmware, etc.) located internal or external to a memory system, is capable of determining (e.g., selecting, setting, adjusting, computing, changing, clearing, communicating, adapting, deriving, defining, utilizing, modifying, applying, etc.) that a memory data error occurs during a memory operation and a memory system fault occurs. The memory control unit may be configured to coordinate reporting of detection of memory data errors with detection of memory system faults.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 includes subject matter (such as a memory system) comprising a memory array including memory cells that are included in one or more memory devices, and a memory control unit operatively coupled to the one or more memory devices. The memory control unit is configured to receive a memory command from a host system; check for memory data errors associated with the memory command; monitor for a memory system fault when performing the memory command; return a response to the host system indicating a data error when a memory data error is detected, memory system fault detection is completed, and a memory system fault is not detected; and return no response to the host system when the memory system fault is detected.

In Example 2, the subject matter of Example 1 optionally includes a memory control unit configured to terminate communication with the host system when the memory system fault is detected.

In Example 3, the subject matter of one or both of Examples 1 and 2 optionally includes a memory control unit configured to decode a memory read command from the host system; check for a read data error associated with the memory read command; encode a response message to the host system that includes the read data when a read data error is not detected, the memory system fault detection is completed, and the memory system fault is not detected; encode a response message to the host system that indicates a read data error when a read data error is detected, the memory system fault detection is completed, and the memory system fault is not detected; and return no response message to the host system when the memory system fault is detected during the read command.

In Example 4, the subject matter of one or any combination of Examples 1-3 optionally includes fault detection circuitry configured to detect one or more of a clock fault, a circuit supply fault, or a firmware fault in the memory system.

In Example 5, the subject matter of Example 4 optionally includes synchronization circuitry configured to synchronize the detection of the one or more of the clock fault, the circuit supply fault, and the firmware fault with detection of memory data errors.

In Example 6, the subject matter of one or any combination of Examples 1-5 optionally includes a memory control unit configured to receive the memory command via a communication link established with the host system, and terminate the communication link when the memory system fault is detected.

In Example 7, the subject matter of one or any combination of Examples 1-6 optionally includes a memory control unit configured to return no response message to the host system when the memory command is completed, and a memory system fault check is not completed.

Example 8 includes subject matter (such as a method of operating a computing system) or can optionally be combined with one or any combination of Examples 1-7 to include such subject matter, comprising receiving, by a memory system of the computing system, a memory command from a host system of the computing system, performing, by the memory system, data error detection for memory data associated with the memory command, monitoring for memory system faults when performing the memory command, returning a response message to the host system for the memory command regarding the data error detection when the monitoring for memory system faults is completed and a memory system fault is not detected, and returning no response message to the host system when the memory system fault is detected.

In Example 9, the subject matter of Example 8 optionally includes the memory system ending communication with the host system when a memory system fault is detected.

In Example 10, the subject matter of one or both of Examples 8 and 9 optionally includes receiving a memory read command from the host system; performing error detection on read data for the memory read command; returning an indication of a read data error to the host system when a read data error is detected, and the memory system fault is not detected; and returning no response message to the host system when the memory system fault is detected during the memory read command.

In Example 11, the subject matter of one or any combination of Examples 8-10 optionally includes monitoring for one or more of a clock fault, a circuit supply fault, or a firmware fault occurs in the memory system.

In Example 12, the subject matter of Example 11 optionally includes synchronizing the detecting of the one or more of the clock fault, the circuit supply fault, and the firmware fault with the error detection of memory data.

In Example 13, the subject matter of one or any combination of Examples 8-12 optionally includes a memory control unit of the memory system returning no response message to the host system when the memory control unit does not receive an indication that memory system fault check was completed.

In Example 14, the subject matter of one or any combination of Examples 8-13 optionally includes establishing, by the host system, a communication link with the memory system, and the memory system receiving the memory command via the communication link, and the memory system terminating the communication link when the memory system fault is detected.

In Example 15, the subject matter of one or any combination of Examples 8-14 optionally includes the memory system receiving a memory write command from the host system, performing error detection on write data for the memory write command, returning an indication of a write data error to the host system when a write data error is detected and the memory system fault is not detected, and returning no response message to the host system when the memory system fault is detected during the memory write command.

Example 16 includes subject matter such as a memory system including a memory array including memory cells that are included in one or more memory devices, and a memory control unit operatively coupled to the one or more memory devices, and a host system including processing circuitry configured to send memory commands to the memory system. The memory control unit is configured to perform error detection on memory data associated with the memory commands; monitor for a memory system fault; return a response message to the host system indicating an error when a memory data error is detected, the monitoring for a memory system fault is completed, and a memory system fault is not detected; and return no response message to the host system when the monitoring for a memory system fault is completed, and the memory system fault is detected.

In Example 17, the subject matter of Example 16 optionally includes a memory control unit configured to end communication with the host system when the memory system fault is detected.

In Example 18, the subject matter of one or both of Examples 16 and 17 optionally includes a host system configured to establish a communication link with the memory system to send the memory commands, and a memory system is configured to terminate the communication link without returning the response message to the host system when the monitoring for a memory system fault is completed and the memory system fault is detected.

In Example 19, the subject matter of one or any combination of Examples 16-18 optionally includes a memory control unit configured to receive a memory read command from the host system; perform error detection on read data for the memory read command; return the read data to the host system when a read data error is not detected, the monitoring for a memory system fault is completed, and the memory system fault is not detected; return the response message to the host system indicating an error when the read data error is detected, the monitoring for a memory system fault is completed, and the memory system fault is not detected; and return no response message to the host system when the memory system fault is detected.

In Example 20, the subject matter of one or any combination of Examples 16-19 optionally includes a memory control unit configured to receive a memory write command from the host system; perform error detection on write data for the memory write command; return the response message to the host system indicating no errors when a write data error is not detected, the monitoring for a memory system fault is completed, and the memory system fault is not detected; return the response message to the host system indicating an error when the write data error is detected the monitoring for a memory system fault is completed, and the memory system fault is not detected; and return no response message to the host system when the memory system fault is detected.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory system comprising:
a memory array including memory cells that are included in one or more memory devices; and
a memory control unit operatively coupled to the one or more memory devices and configured to:
receive a memory command from a host system;
check for memory data errors associated with the memory command;
monitor for a memory system fault when performing the memory command;
return a response to the host system indicating a data error when a memory data error is detected, memory system fault detection is completed, and a memory system fault is not detected; and
return no response to the host system when the memory system fault is detected.

2. The memory system of claim 1, wherein the memory control unit is configured to terminate communication with the host system when the memory system fault is detected.

3. The memory system of claim 1, wherein the memory control unit is configured to:
decode a memory read command from the host system;
check for a read data error associated with the memory read command;
encode a response message to the host system that includes the read data when a read data error is not detected, the memory system fault detection is completed, and the memory system fault is not detected;
encode a response message to the host system that indicates a read data error when a read data error is detected, the memory system fault detection is completed, and the memory system fault is not detected; and
return no response message to the host system when the memory system fault is detected during the read command.

4. The memory system of claim 1, including fault detection circuitry configured to detect one or more of a clock fault, a circuit supply fault, or a firmware fault in the memory system.

5. The memory system of claim 4, including synchronization circuitry configured to synchronize the detection of the one or more of the clock fault, the circuit supply fault, and the firmware fault with detection of memory data errors.

6. The memory system of claim 1, wherein the memory control unit is configured to:
receive the memory command via a communication link established with the host system; and
terminate the communication link when the memory system fault is detected.

7. The memory system of claim 1, wherein the memory control unit is configured to return no response message to the host system when the memory command is completed and a memory system fault check is not completed.

8. A method of operating a computing system, the method comprising:
receiving, by a memory system of the computing system, a memory command from a host system of the computing system;
performing, by the memory system, data error detection for memory data associated with the memory command;
monitoring for memory system faults when performing the memory command;
returning a response message to the host system for the memory command regarding the data error detection when the monitoring for memory system faults is completed and a memory system fault is not detected; and
returning no response message to the host system when the memory system fault is detected.

9. The method of claim 8, wherein the returning no response message includes the memory system ending communication with the host system when a memory system fault is detected.

10. The method of claim 8,
wherein the receiving a memory command from the host system includes receiving a memory read command from the host system;
wherein the performing error detection includes performing error detection on read data for the memory read command;
wherein the returning the response message includes returning an indication of a read data error to the host system when a read data error is detected and the memory system fault is not detected; and
wherein the returning no response message includes returning no response message to the host system when the memory system fault is detected during the memory read command.

11. The method of claim 8, wherein the monitoring for a memory system fault includes monitoring for one or more of a clock fault, a circuit supply fault, or a firmware fault occurs in the memory system.

12. The method of claim 11, including synchronizing the detecting of the one or more of the clock fault, the circuit supply fault, and the firmware fault with the error detection of memory data.

13. The method of claim 8, including a memory control unit of the memory system returning no response message to the host system when the memory control unit does not receive an indication that memory system fault check was completed.

14. The method of claim 8, including:
establishing, by the host system, a communication link with the memory system;
wherein the receiving the memory command includes the memory system receiving the memory command via the communication link; and
wherein the returning no response message to the host system includes the memory system terminating the communication link when the memory system fault is detected.

15. The method of claim 8,
wherein the receiving a memory command from the host system includes receiving a memory write command from the host system;
wherein the performing error detection includes performing error detection on write data for the memory write command;
wherein the returning the response message includes returning an indication of a write data error to the host system when a write data error is detected, and the memory system fault is not detected; and
returning no response message to the host system when the memory system fault is detected during the memory write command.

16. A computing system comprising:
a memory system including a memory array including memory cells that are included in one or more memory devices, and a memory control unit operatively coupled to the one or more memory devices; and
a host system including processing circuitry configured to send memory commands to the memory system; and
wherein the memory control unit is configured to:
perform error detection on memory data associated with the memory commands;
monitor for a memory system fault;
return a response message to the host system indicating an error when a memory data error is detected, the monitoring for a memory system fault is completed, and a memory system fault is not detected; and
return no response message to the host system when the monitoring for a memory system fault is completed, and the memory system fault is detected.

17. The computing system of claim 16, wherein memory control unit is configured to end communication with the host system when the memory system fault is detected.

18. The computing system of claim 16,
wherein the host system is configured to establish a communication link with the memory system to send the memory commands; and
wherein the memory system is configured to terminate the communication link without returning the response message to the host system when the monitoring for a memory system fault is completed and the memory system fault is detected.

19. The computing system of claim 16, wherein the memory control unit is configured to:
receive a memory read command from the host system;
perform error detection on read data for the memory read command;
return the read data to the host system when a read data error is not detected, the monitoring for a memory system fault is completed, and the memory system fault is not detected;
return the response message to the host system indicating an error when the read data error is detected, the monitoring for a memory system fault is completed, and the memory system fault is not detected; and
return no response message to the host system when the memory system fault is detected.

20. The computing system of claim 16, wherein the memory control unit is configured to:
receive a memory write command from the host system;
perform error detection on write data for the memory write command;
return the response message to the host system indicating no errors when a write data error is not detected, the monitoring for a memory system fault is completed, and the memory system fault is not detected;
return the response message to the host system indicating an error when the write data error is detected the monitoring for a memory system fault is completed, and the memory system fault is not detected; and
return no response message to the host system when the memory system fault is detected.
